(19) United States
(12) Patent Application Publication
(10) Pub. No.: US 2018/0273281 A1
(43) Pub. Date: Sep. 27, 2018

(54) LIQUID CONTAINERS WITH PORTS

(71) Applicant: Greg Latimer, Aumsville, OR (US)

(72) Inventor: Greg Latimer, Aumsville, OR (US)

(21) Appl. No.: 15/991,963

(22) Filed: May 29, 2018

(51) Int. Cl. B65D 83/48; B65D 25/38; F16K 15/04

(52) U.S. Cl. CPC B65D 83/48; B65D 1/20; F16K 15/044; B65D 25/385

(57) ABSTRACT

A container to store a liquid. The container may include a body with a cavity to store a liquid. The container may include a valve with a housing and a closing member. The housing may include a conduit connecting a first opening at a top of the valve to a second opening at a bottom of the valve, where the top of the valve faces an exterior of the housing and the bottom of the valve faces the cavity of the housing. The closing member may be located within the conduit, where the closing member may control a flow of matter from the second opening to the first opening.

### BACKGROUND

Motorized vehicles and machines often use fossil fuels to power the motorized vehicles or machines. A fuel station, such as a gas station, may provide a location for users of the motorized vehicles and machines to fill up their motorized vehicles and machines with the fossil fuels. However, the fuel stations may not always be conveniently located or open when an individual needs the fossil fuels. A portable fuel container, such as a gas can, may be used to by the individual to store a fossil fuel and fill up the fuel tanks of the motorized vehicles and machines without the individual traveling to the fuel station each time additional fossil fuels are desired.

### SUMMARY

A container to store a liquid. The container may include a body with a cavity to store a liquid. The container may include a valve. The valve may include a housing with a conduit connecting a first opening at a top of the valve to a second opening at a bottom of the valve, where the top of the valve faces an exterior of the housing and the bottom of the valve faces the cavity of the housing. The valve may include a closing member located within the conduit, where the closing member may control a flow of matter from the second opening to the first opening.

### BRIEF DESCRIPTION OF THE DRAWINGS

The present description will be understood more fully from the detailed description given below and from the accompanying drawings of various embodiments of the present embodiment, which is not to be taken to limit the present embodiment to the specific embodiments but are for explanation and understanding.

FIG. 1 illustrates a liquid container with a first valve and a second valve, according to an embodiment.

FIG. 2A illustrates a side perspective view of the first valve with the cover, according to an embodiment.

FIG. 2B illustrates a side perspective view of the first valve with the cover fully fastened onto the threads, according to an embodiment.

FIG. 2C illustrates an exposed side view of the first valve with the cover fully fastened onto the threads, according to an embodiment.

FIG. 2D illustrates an exposed side view of the first valve with the cover partially fastened to the threads, according to an embodiment.

FIG. 2E illustrates an exposed side view of the first valve with the cover unfastened from the threads, according to an embodiment.

FIG. 3A illustrates an exposed side perspective view of the first valve with the cover unfastened from the threads, according to an embodiment.

FIG. 3B illustrates the closing member in an open position, according to one embodiment.

FIG. 4A illustrates a side perspective view of the second valve, according to an embodiment.

FIG. 4B illustrates a side perspective view of the second valve, according to an embodiment.

FIG. 4C illustrates an exposed side perspective view of the second valve, according to an embodiment.

FIG. 4D illustrates the closing member in an open position, according to one embodiment.

### DETAILED DESCRIPTION

The disclosed liquid containers will become better understood through review of the following detailed description in conjunction with the figures. The detailed description and figures provide merely examples of the various liquid containers described herein. Those skilled in the art will understand that the disclosed examples may be varied, modified, and altered without departing from the scope of the liquid containers described herein. Many variations are contemplated for different applications and design considerations; however, for the sake of brevity, each and every contemplated variation is not individually described in the following

Throughout the following detailed description, examples of various liquid containers are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader is to understand that a given feature need not be the same or similar to the specific portrayal of a related feature in any given figure or example.

Liquid containers, such as gas cans, are an easy way to store and transport fuel and other liquids. Conventional liquid containers include a single large storage area of the container that may hold a liquid and a single opening to pour the liquid out. The lack of ports in the liquid container may hamper a usability and functionality of the liquid container. For example, conventionally when a liquid is poured out of a liquid container, the flow of the liquid is restricted based on an amount of liquid flowing out of a mouth of the liquid container and the amount of air flowing into the mouth of the liquid container. Additionally, when the amount of liquid flowing out of the mouth exceeds a threshold amount, there may be insufficient air flowing into the liquid container, causing the liquid to erratically or unevenly flow out of the liquid container. In another example, conventionally when certain liquids or vapors leaving the liquid container (such as gasoline or gas vapors) contact a source of ignition (such as a flame or a spark) the liquid container may explode. For example, the vapor outside the liquid container may ignite and flashback inside the liquid container. When the ignited liquid becomes trapped within the liquid container without an exit opening, the liquid may combust and cause an explosion.

Implementations of the disclosure address the above-mentioned deficiencies and other deficiencies by providing a liquid container with one or more ports. In one embodiment, the liquid container may include a port valve to allow air to enter the liquid container so that as liquid is poured from the liquid container, there is sufficient air for a controlled and even flow of the liquid from a mouth opening. In another embodiment, the liquid container may include a safety release port to allow the matter, such as vapors or flames, to exit the liquid container. The ports of the liquid container may increase a functionality and safety of the liquid container.

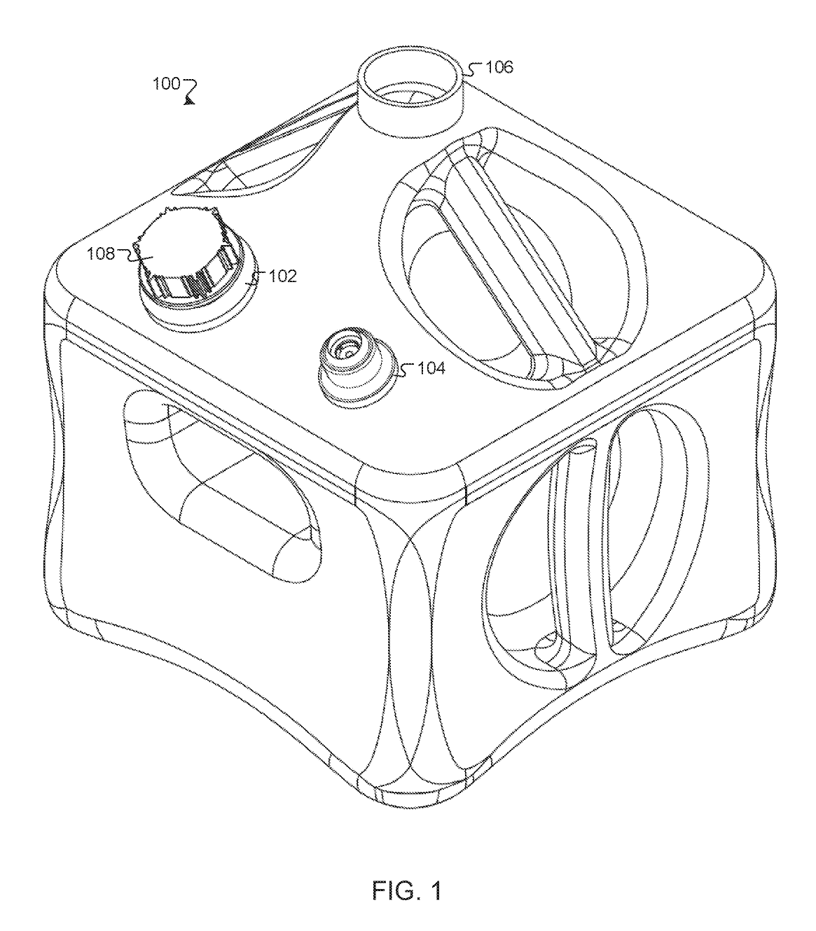

FIG. 1 illustrates a liquid container 100 with a first valve 102 and a second valve 104, according to an embodiment. In one example, the liquid container 100 may include a mouth opening 106. The mouth opening 106 may be an opening in the liquid container 100 for the liquid to be placed into the liquid container 100 or taken out of the liquid container 100. In one example, the liquid may be poured into the liquid container 100 via the mouth opening 106 to fill the liquid container 100 with the liquid. In another example, the liquid container 100 may be tilted so that liquid stored in the liquid container 100 may be poured out of the mouth opening 106. The mouth opening 106 may be formed to connect with nozzles, lids, or other attachments. In one example, the mouth opening 106 may include threads to screw the nozzles, the lids, or the other attachments onto the mouth opening 106. In another example, the mouth opening may include a fastener to attach the nozzles, the lids, or the other attachments onto the mouth opening 106.

In one example, the first valve 102 may be integrated into a body of the liquid container 100. For example, the first valve 102 may be integrated into a top surface, a side surface, or a bottom surface of the liquid container 100. In one embodiment, the first valve 102 may be a valve to regulate an amount of air that may enter a chamber or cavity of the liquid container 100. For example, the first valve 102 may include a first opening along an outer surface of the liquid container 100 and a channel that extends to the chamber or cavity of the liquid container 100. As discussed below, the first valve 102 may also include a cover 108 that may be removably attached to a top of the first valve 102. The cover 108 may be adjusted to increase or decrease an amount of air that may enter into the chamber or cavity of the liquid container 100. In one example, as the amount of air flowing into the chamber or cavity increase, a rate that the liquid stored in the chamber or cavity flows out of the mouth opening 106 may increase. In another example, as the amount of air flowing into the chamber or cavity decrease, a rate that the liquid stored in the chamber or cavity flows out of the mouth opening 106 may decrease.

In another example, the second valve 104 may be integrated into a body of the liquid container 100. For example, the second valve 104 may be integrated into a top surface, a side surface, or a bottom surface of the liquid container 100. In one embodiment, the second valve 104 may be a safety release port to allow the matter to exit the liquid container. In one example, the matter may be excess vapors that build up in the chamber or cavity of the liquid container 100. In another example, the matter may be a flame when the liquid in the chamber or cavity of the liquid container 100 is ignited. When the second valve 104 is a safety release port, the safety release port may allow excess matter to be released or expelled from the liquid container 100 to allow a user to use the liquid container 100 safely by reducing or eliminating built up pressure and/or matter or unwanted matter from being contained in the chamber or cavity of the liquid container 100.

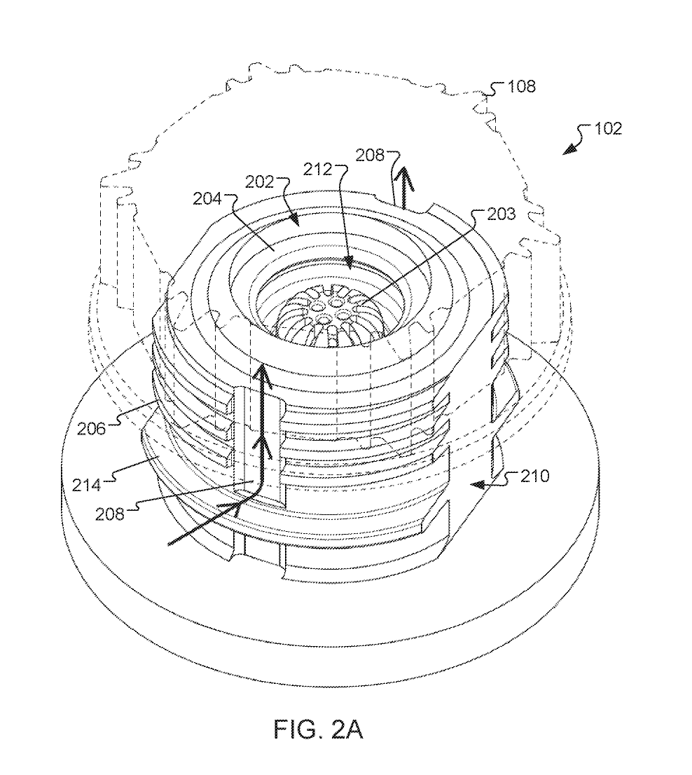

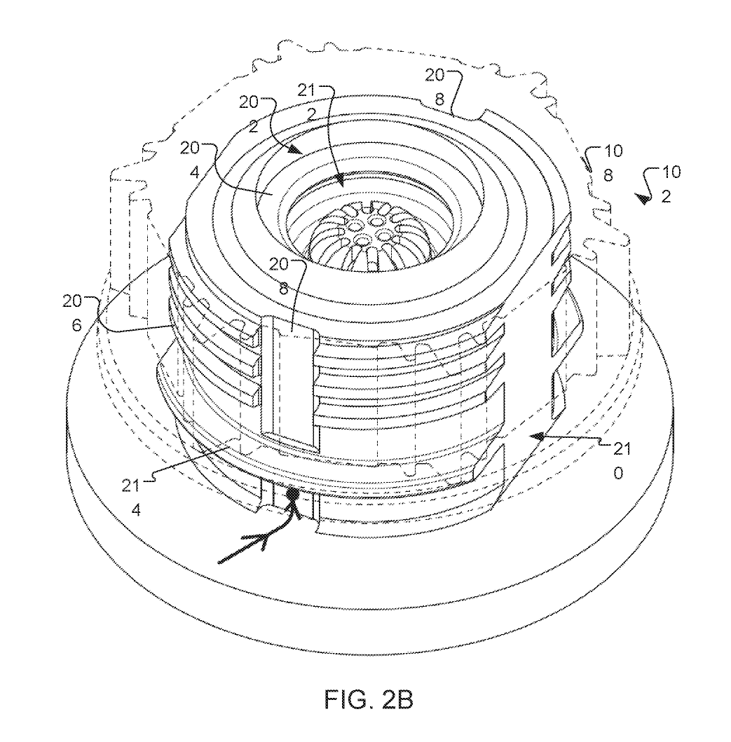

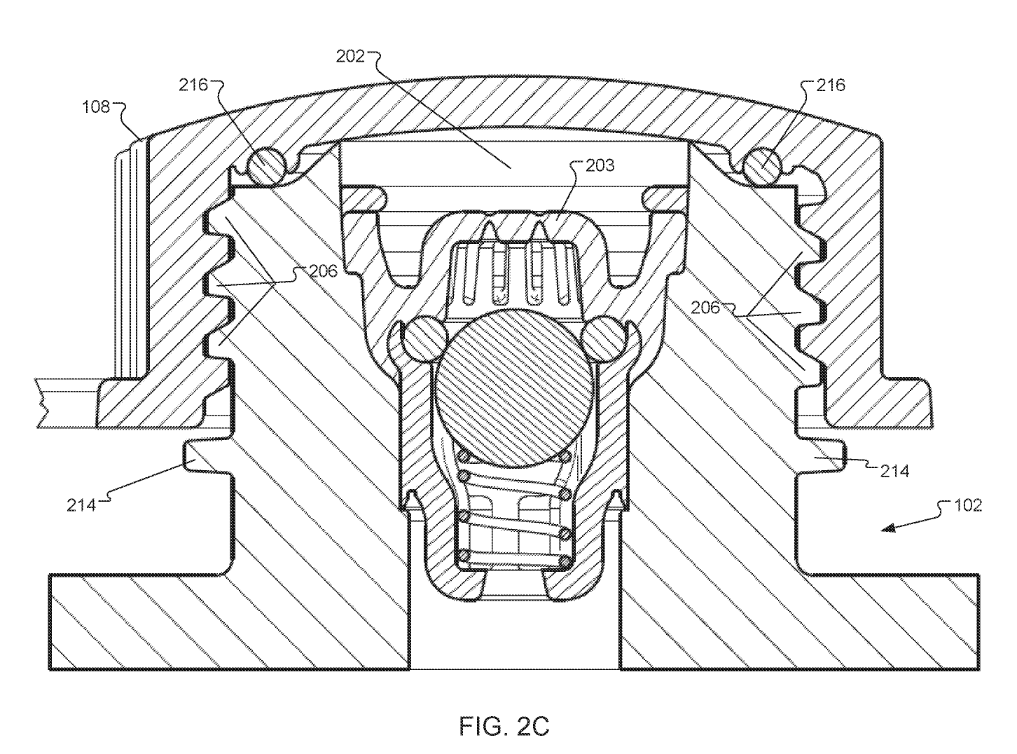

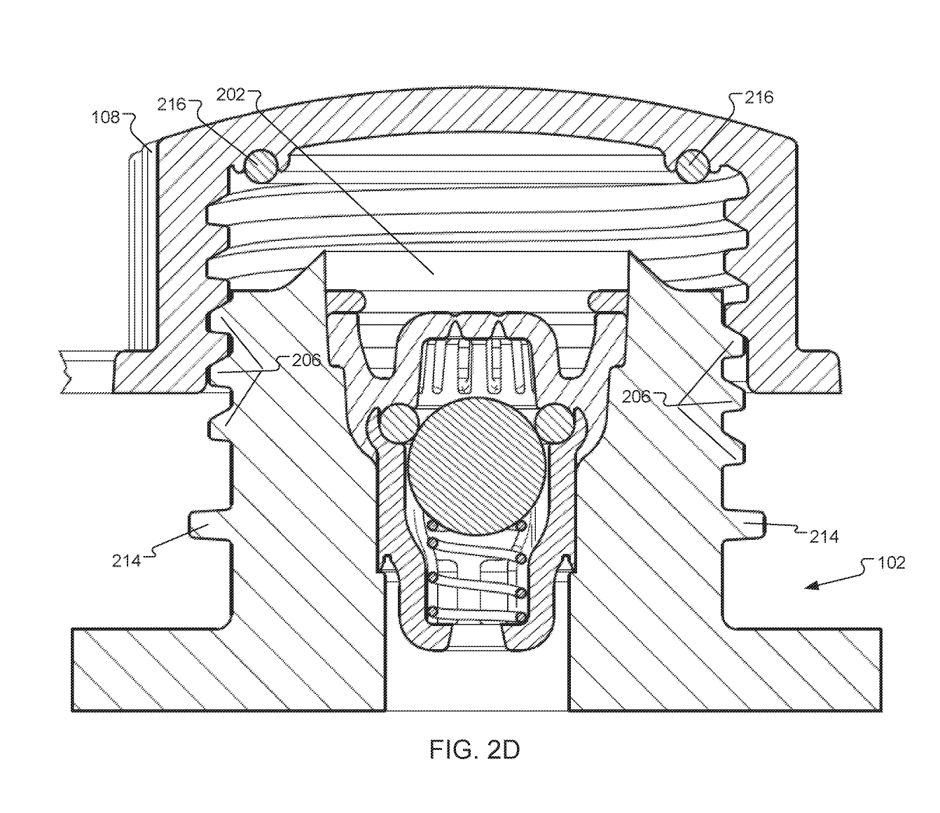

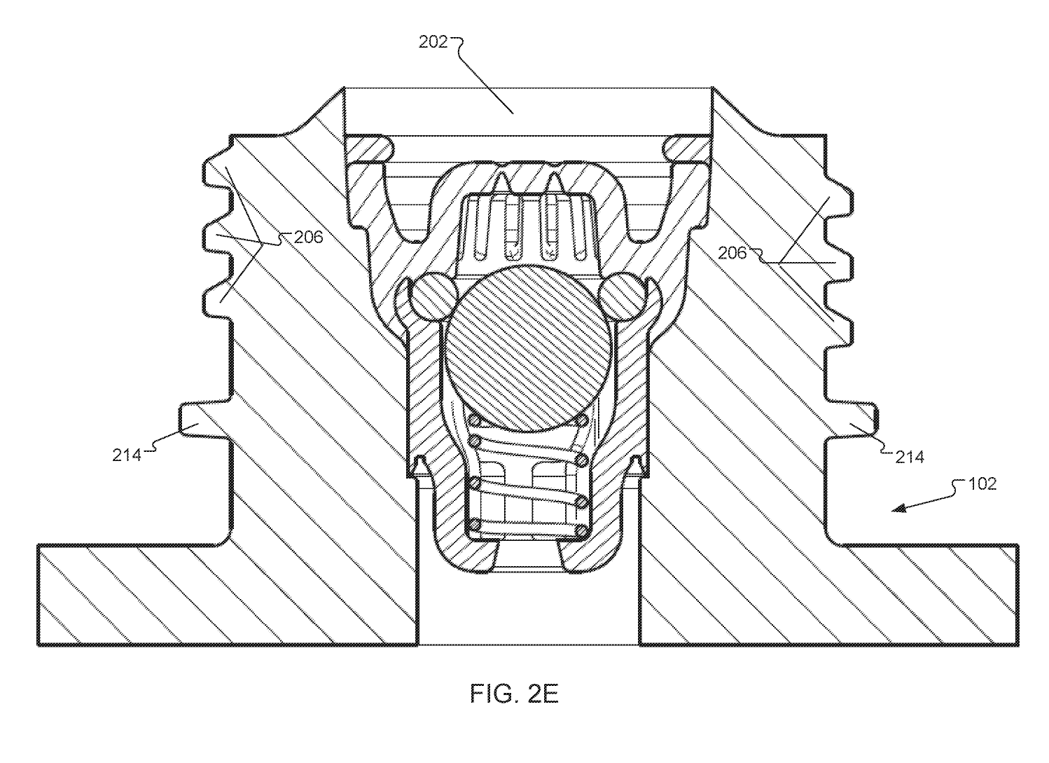

FIG. 2A illustrates a side perspective view of the first valve 102 with the cover 108, according to an embodiment. Some of the features in FIG. 2A are the same or similar to some of the features in FIG. 1 as noted by the same reference numbers, unless expressly described otherwise. As discussed above, the first valve 102 may be a valve to regulate an amount of air that may enter a chamber or cavity of the liquid container 100 of FIG. 1. In one embodiment, the first valve 102 may include an opening 202 where air may flow from the exterior of the liquid container 100 into the cavity or chamber of the liquid container 100. For example, the opening 202 may be a conduit from the cavity or the chamber of the liquid container 100 to the environment surrounding the liquid container 100. The opening 202 may include a cap 203 that may restrict larger materials from entering the conduit.

In one embodiment, a portion of the first valve 102 may be press-fitted into the opening 202, as discussed below. For example, a first portion 210 of the first valve 102 may be integrated into the liquid container 100 or be part of a molded body of the liquid container 100. The first portion 210 of the first valve 102 may include the opening 202. A second portion 212 of the first valve 102 may be an insert that includes one or more parts that may be press-fitted into the opening 202. The first valve 102 may include a retainer clip 204 to aid in retaining the second portion 212 of the first valve 102 that is press-fitted into the opening 202.

The first portion 210 of the first valve 102 may include first set of threads 206. The first set of threads 206 may be projecting helical rib that the cover 108 may be fastened on to. The first set of threads 206 may include channels 208 at a portion of the first set of threads 206. The channels 208 may extend vertically from a bottom portion of the first set of threads 206 to a top portion of the first set of threads 206. In one embodiment, the channels 208 may extend vertically for a bottom end of the first set of threads 206 to a top end of the first set of threads 206 to provide a channel that extends the full vertical length of the first set of threads 206. In another embodiment, the channels 208 may extend vertically along a portion of the first set of threads 206. For example, a bottom portion of the first set of threads 206 may include a stopper thread 214 at the bottom of the first set of threads 206 that does not include the channels 208. The stopper thread 214 may stop the cover 108 from being screwed down any further along the first set of threads 206. The channels 208 may extend vertically at a location above the stopper thread 214 to a top of the first set of threads 206.

The channels 208 may provide a groove or a cutout in the first set of threads 206 that may provide a path for air to enter the opening 202 of the first valve 102. To fasten the cover 108 to the first valve 102, the cover 108 may include a second set of thread that run along an inner cavity of the cover 108.

In one example, when the cover 108 is fully fastened onto the first set of threads 206 down to the stopper thread 214, the cover 108 may form a seal around the stopper thread 214 that may restrict air from flowing along the channels 208. As the cover 108 is unfastened from the first valve 102 along the first set of threads 206, the cover 108 may expose the channels 208 to the air surrounding the first valve 102. As the channels 208 are exposed to the air, the air may flow into the opening 202 via the channels 208. The rate that the air flows into the opening 202 via the channels 208 may be adjusted based on the amount of the cover 108 that is fastened onto the first set of threads 206. For example, when the cover 108 is unfastened a relatively small amount along the first set of threads 206, such as exposing a single rib of the first set of threads 206, a relatively small amount of air may enter the opening 202 via the channels 208. In another example, as the cover 108 is unfastened a relatively large amount along the first set of threads 206, such as exposing multiple ribs of the thread 206, a relatively large amount of air may enter the opening 202 via the channels 208. In another example, when the cover 108 is fully unfastened from the first set of threads 206 so that the cover 108 is not connected to the first set of threads 206, the air may freely flow into the opening 202 along the channels 208 and/or directly into the opening 202.

When the cover 108 is fully unfastened from the first set of threads 206, the rate that the air may flow into the cavity or chamber of the liquid container 100 via the opening 202 may be based at least in part on a size or diameter of the opening 202. As the size or diameter of the opening 202 increases, the rate that the air may enter the cavity or chamber of the liquid container 100 may increase. As the size or diameter of the opening 202 decreases, the rate that the air may enter the cavity or chamber of the liquid container 100 may decrease. As discussed below, the second portion 212 of the first valve 102 may include other parts or pieces that may also regulate a flow of the air into the cavity or chamber of the liquid container 100.

FIG. 2B illustrates a side perspective view of the first valve 102 with the cover 108 fully fastened onto the first set of threads 206, according to an embodiment. Some of the features in FIG. 2B are the same or similar to some of the features in FIGS. 1 and 2A as noted by the same reference numbers, unless expressly described otherwise. As discussed above, the first set of threads 206 may include channels 208 that may be a groove or a cutout in the first set of threads 206 to provide a path for air to enter the opening 202 of the first valve 102. When the cover 108 is entirely fastened onto the first set of threads 206 down to the stopper thread 214, the cover 108 may form a seal around the stopper thread 214 that may at least partially restrict air from flowing along the channels 208. In another example, the cover 108 may also restrict liquid from leaving the cavity or chamber of the liquid container 100 via the opening 202. For example, the cap may be a stopper to restrict or limit an amount of liquid from leaving the cavity or chamber of the liquid container 100 and/or restrict or limit an amount of air from entering the cavity or chamber of the liquid container 100.

FIG. 2C illustrates an exposed side view of the first valve 102 with the cover 108 fully fastened onto the first set of threads 206, according to an embodiment. Some of the features in FIG. 2C are the same or similar to some of the features in FIGS. 1 and 2A-2B as noted by the same reference numbers, unless expressly described otherwise. As discussed above, the first valve 102 may be a valve to regulate an amount of air that may enter a chamber or cavity of the liquid container 100 of FIG. 1 via the opening 202. When the cover 108 is fully fastened onto the first set of threads 206, the cover 108 may stop the flow of air from entering the chamber or cavity of the liquid container 100 of FIG. 1 via the opening 202. In one example, the cover 108 may form a seal with the stopper thread 214 to stop the flow of air from entering the chamber or cavity of the liquid container 100 of FIG. 1 via the opening 202. In another example, the cover 108 may include a gasket 216 that may form a seal around a top of the first valve 102 to stop the flow of air from entering the chamber or cavity of the liquid container 100 of FIG. 1 via the opening 202.

FIG. 2D illustrates an exposed side view of the first valve 102 with the cover 108 partially fastened to the first set of threads 206, according to an embodiment. Some of the features in FIG. 2D are the same or similar to some of the features in FIGS. 1 and 2A-2C as noted by the same reference numbers, unless expressly described otherwise. As discussed above, the first valve 102 may be a valve to regulate an amount of air that may enter a chamber or cavity of the liquid container 100 of FIG. 1 via the opening 202. When the cover 108 is partially fastened to the first set of threads 206, the cover 108 may engage one or more of the first set of threads 206 and there may be a gap between the cover 108 and the top of the first valve 102 and/or the stopper thread 214. When there is a gap between the cover 108 and the top of the first valve 102 and/or the stopper thread 214, air may flow into the enter a chamber or cavity of the liquid container 100 of FIG. 1 through the opening 202.

As discussed above, the air may be channeled to the opening 202 by the channels 208 in FIG. 2B. For example, when the cover 108 is partially fastened to the first set of threads 206, air may be allowed to enter the channels 208. The air may flow through the channels 208 into the opening 202 and enter the chamber or cavity of the liquid container 100 of FIG. 1. As the cover 108 is screwed onto or off of the first set of threads 206 the flow rate of the air into the opening 202 may vary. For example, when the gap between the cover 108 and the top of the first valve 102 and/or the stopper thread 214 is relatively small, such as when the cover 108 is unscrewed from one thread 206, the cover 108 may cover a substantial amount of the channels 208 and the amount of air that may enter the channels 208 may be restricted to a longer path as the air flows under the cover 108 to the channel and then into the opening 202. In another example, when the gap between the cover 108 and the top of the first valve 102 and/or the stopper thread 214 is relatively large, such as when the cover 108 is unscrewed from several of the threads in the first set of threads 206, the cover 108 may not cover a substantial amount of the channels 208. When the gap is relatively large and the amount of air that may enter the channels 208 may increase because the path for the air to flow under the cover 108 to the channels 208 and then into the opening 202 may be short.

FIG. 2E illustrates an exposed side view of the first valve 102 with the cover 108 unfastened from the first set of threads 206, according to an embodiment. Some of the features in FIG. 2E are the same or similar to some of the features in FIGS. 1 and 2A-2D as noted by the same reference numbers, unless expressly described otherwise. As discussed above, the first valve 102 may be a valve to regulate an amount of air that may enter a chamber or cavity of the liquid container 100 of FIG. 1 via the opening 202. When the cover 108 is unfastened from the first set of threads 206, the air may flow freely into the chamber or cavity of the liquid container 100 of FIG. 1 through the opening 202. When the cover 108 is removed from the thread 206, a size of the opening 202 may determine a maximum flow rate of the air into the chamber or cavity of the liquid container 100. In one example, the size or diameter of the opening 202 may be adjusted to change the maximum flow rate of the air into the chamber or cavity of the liquid container 100.

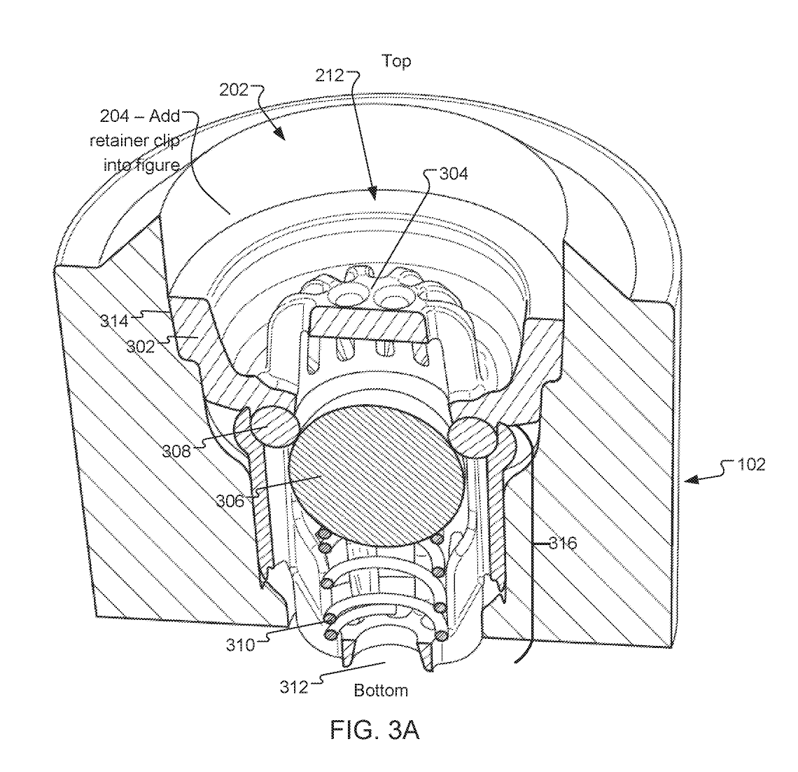

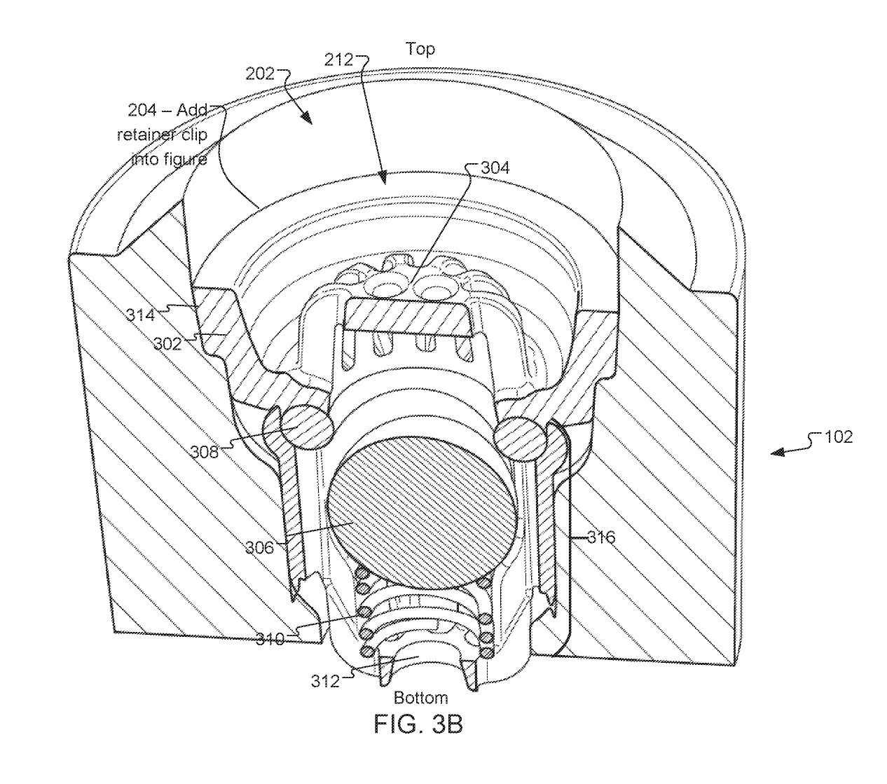

FIG. 3A illustrates an exposed side perspective view of the first valve 102 with the cover 108 unfastened from the first set of threads 206, according to an embodiment. Some of the features in FIG. 3A are the same or similar to some of the features in FIGS. 1 and 2A-2E as noted by the same reference numbers, unless expressly described otherwise. As discussed above, the first valve 102 may include a second portion 212 of the first valve 102 that is press-fitted into the opening 202.

The second portion 212 of the first valve 102 may be a check valve, a clack valve, a non-return valve, a reflux valve, a retention valve, a one-way valve, and so forth. For example, the second portion 212 of the first valve 102 may be a one-way ball valve, such as a one-way ball check valve. The one-way ball check valve may allow air to flow into the cavity or chamber of the liquid container 100 while stopping matter, such as liquid or gas, from flowing out of the cavity or the chamber of the liquid container 100 through the first valve 102. The second portion 212 of the first valve 102 may include a cap 302, a closing member 316, and/or an opening 312.

The cap 302 may be a located at a top of the second portion 212 that faces the outside or exterior of the liquid container 100. The cap 302 may be a porous apparatus for removing or filtering out impurities, debris, or solid particles from passing through the opening 202 to the cavity or chamber of the liquid container 100. For example, the cap 302 may be affixed to an inner wall 314 of the first portion 210 of the first valve 102. The cap 302 may form a seal around the inner wall 314. The cap 302 may include an opening 304 at a center or middle portion of the cap 302. In one embodiment, the opening 304 may be an unobstructed opening that provides a path for the air to the closing member 316. In another embodiment, the opening 304 may be slot, holes, or pores in the cap 302 that allow air to flow toward the closing member 316 and removing or filter out impurities, debris, solid particles from the air.

The closing member 316 may be configured to have a closed position to restrict to the flow of air to the opening 312 of the second portion 212 and an open position to allow the flow of air to the opening 312. To restrict or allow the flow of air to the opening 312, the closing member 316 may include a blocker 306, a seal 308, and an elevator 310. The blocker 306 may be positioned on the elevator 310 to raise or lower the blocker 306 when downward pressure is applied to the blocker 306. The blocker 306 may be a ball, a disk, a plate, and so forth. The elevator 310 may be a spring, a coil, a mechanical actuator, and so forth. The blocker 306 and/or the elevator 310 may be a metal material, a plastic material, a rubber material, a glass material, and so forth. For example, the blocker 306 may be a ball and the elevator 310 may be a spring. The ball may rest on top of the spring. The seal 308 may be affixed or connected to an inner portion of the cap 302. For example, the seal 308 may be an O-ring that circumscribes an opening in the cap 302.

FIG. 3A illustrates the closing member 316 in a closed position where the spring is decompressed into a decompressed configuration and the spring is pressing the ball into the seal 308 to form a seal between the ball and the seal 308. When the ball forms a seal with the seal 308, material (such as a gas, a liquid, or a solid) may not pass through the closing member to the opening 312. In another embodiment, the blocker 306 may form a seal directly with a body of the closing member 316 and/or the cap 302.

FIG. 3B illustrates the closing member 316 in an open position, according to one embodiment. Some of the features in FIG. 3B are the same or similar to some of the features in FIGS. 1, 2A-2E, and 3A as noted by the same reference numbers, unless expressly described otherwise. When a threshold amount of pressure is applied to the elevator 310 to compress the elevator 310, the closing member 316 may be in the open position where there may be a gap between the blocker 306 and the seal 308 to allow air to flow through the gap to the opening 312. In one example, material from the top side of the second portion 212 may apply pressure to the elevator 310 to compress the elevator 310 and allow the material to flow to the opening 312. In another example, as a liquid in the liquid container 100 is poured from the mouth opening 106 in FIG. 1, a vacuum may be created in the chamber or cavity of the liquid container 100 that may suck the blocker 306 downward to compress the elevator 310. As the elevator 310 compresses, the closing member 316 may switch from a closed position to an open position and allow the material, such as air, to enter the cavity or chamber of the liquid container 100 via the opening 312. A body of the closing member 316 may be sloped or curved to limit a range that the blocker 306 may be lifted or raised by the elevator 310.

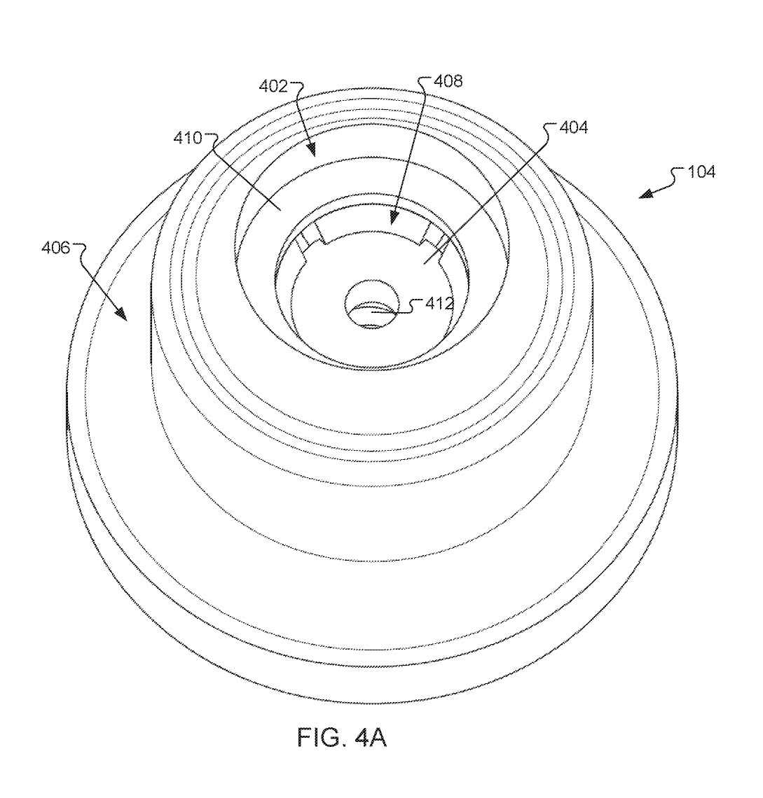

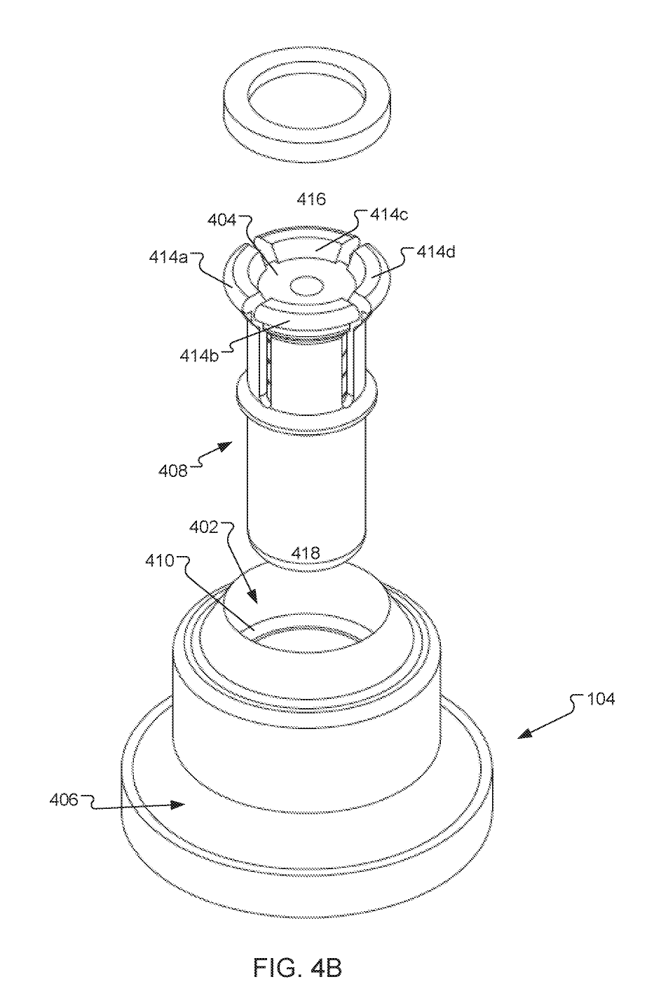

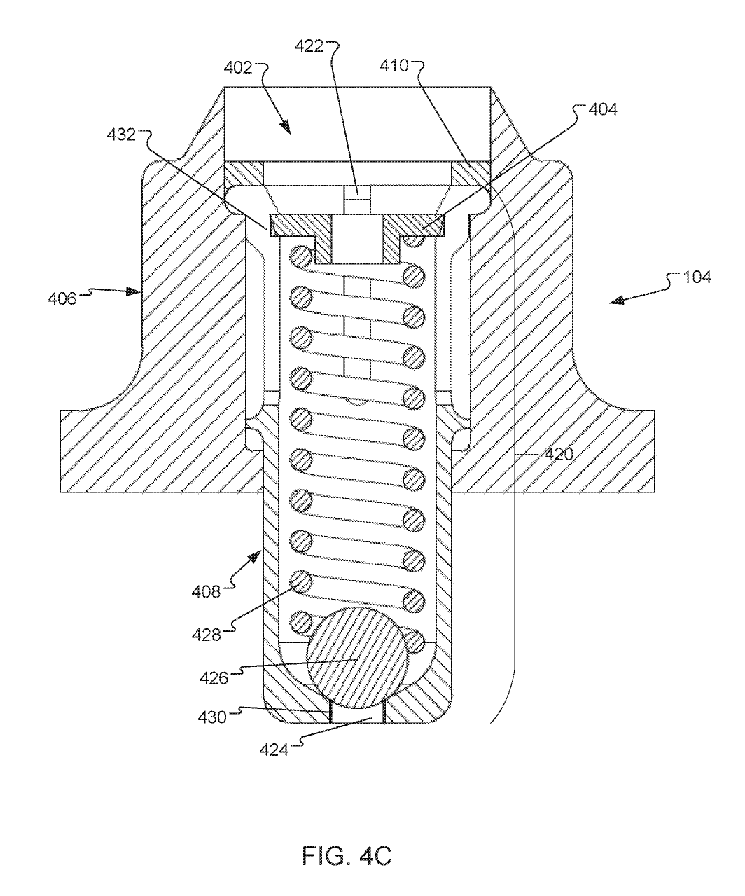

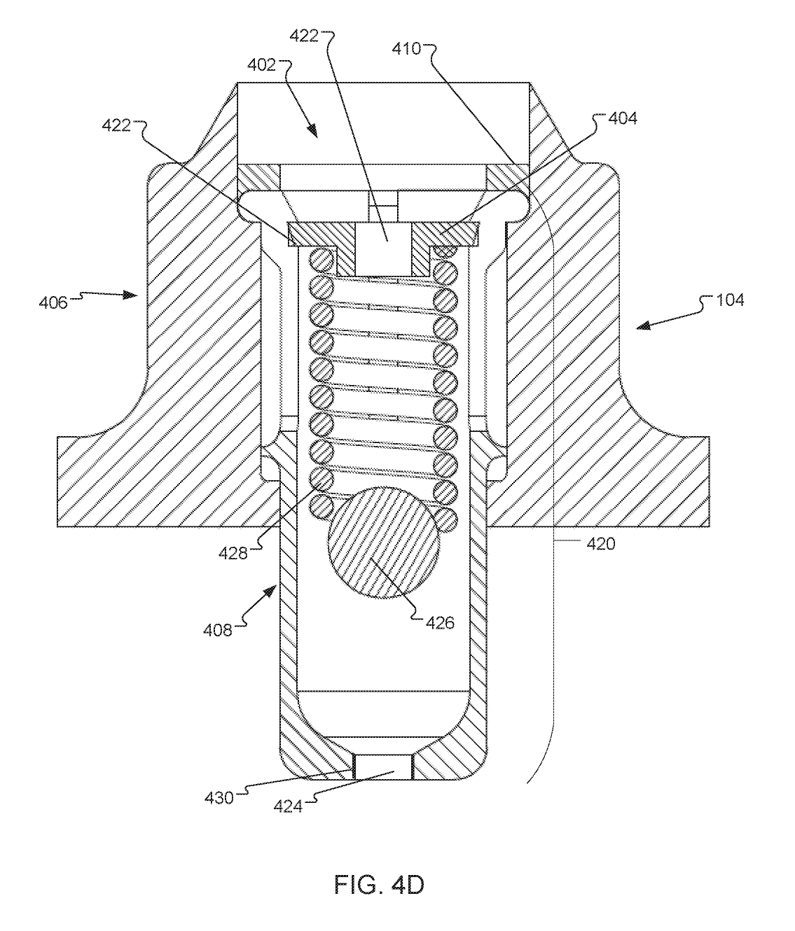

FIG. 4A illustrates a side perspective view of the second valve 104, according to an embodiment. Some of the features in FIG. 4A are the same or similar to some of the features in FIG. 1 as noted by the same reference numbers, unless expressly described otherwise. As discussed above, the second valve 104 may be a valve to regulate an amount of material that may exit the chamber or cavity of the liquid container 100 of FIG. 1. In one embodiment, the second valve 104 may include an opening 402 where the material may flow from the chamber or cavity of the liquid container 100 to an area approximate the liquid container 100. For example, the opening 402 may be a conduit from the cavity or the chamber of the liquid container 100 to the environment surrounding the liquid container 100. The opening 402 may include a cap 404 that may regulate an amount of material that exits through the conduit. The material may be a gas, vapors, flames, a liquid, and so forth.

In one embodiment, a portion of the second valve 104 may be press-fitted into the opening 402. For example, a first portion 406 of the second valve 104 may be integrated into the liquid container 100 or be part of a molded body of the liquid container 100. The first portion 406 of the second valve 104 may include the opening 402. A second portion 408 of the second valve 104 may be an insert that includes one or more parts that may be press-fitted into the opening 402. The second valve 104 may include a retainer clip 410 to aid in retaining the second portion 408 of the second valve 104 that is press-fitted into the opening 402.

The cap 404 may include an opening 412 to provide a path for material to exit the second valve 104. As discussed below, the second portion 408 may be a check valve has an opened position and a closed position. In the opened position, the check valve may allow the material to vent from the liquid container 100 via the opening 412. In the closed position, the check valve may restrict the material from venting from the liquid container 100 via the opening 412. The rate that the material vents from the opening 412 may be adjusted based a size or diameter of the opening 412. For example, when the opening is relatively small (such as less than one-third the diameter of the cap 404), the amount of material that may be vented may be relatively small. In another example, when the opening is relatively large (such as greater than one-third the diameter of the cap 404), the amount of material that may be vented may be relatively large. As discussed below, the second portion 408 of the second valve 104 may include other parts or pieces that may also regulate a flow of the air out of the cavity or chamber of the liquid container 100.

FIG. 4B illustrates a side perspective view of the second valve 104, according to an embodiment. Some of the features in FIG. 4B are the same or similar to some of the features in FIGS. 1 and 4A as noted by the same reference numbers, unless expressly described otherwise. As discussed above, the second portion 408 of the second valve 104 may be an insert that includes one or more parts that may be press-fitted into the opening 402 of the first portion 406 of the second valve 104. For example, the second portion 408 may include a top side 416 and a bottom side 418. The bottom side 418 may be inserted into the opening 402. The second portion 408 may then be pressed downward into the opening 402 of the first portion 406 of the second valve 104.

The top side 416 of the second portion 408 may include slits or slots that may divide the top side 416 of the second portion 408 into multiple parts. For example, the top side 416 of the second portion 408 may include four slits that may divide the top side 416 into four wings 414a, 414b, 414c, and 414d. When the second portion 408 of the second valve 104 is not inserted into the opening 402, the wings 414a-d may each extend outwardly. As the second portion 408 is inserted into the opening, the wings 414a-d may be compressed inwardly. When the second portion 408 has been inserted into the opening 402, an outward pressure of the wings 414a-d may produce pressure and friction between the wings 414a-d and the inner wall of the opening 402. The pressure and friction between the wings 414a-d and the inner wall of the opening 402 may create a friction fit between the first portion 406 and the second portion 408. In another embodiment, the second portion 408 may be inserted into the opening 402 and the retaining clip 410 may be inserted into the opening above the second portion 408 to retain the second portion 408 within the opening 402. In another embodiment, the wings 414a-d and the retaining clip 410 may both be used to retain the second portion 408 within the opening 402.

FIG. 4C illustrates an exposed side perspective view of the second valve 104, according to an embodiment. Some of the features in FIG. 4C are the same or similar to some of the features in FIGS. 1 and 4A-4B as noted by the same reference numbers, unless expressly described otherwise. As discussed above, the second valve 104 may include the second portion 408 of the second valve 104 that is press-fitted into the opening 402.

The second portion 408 of the second valve 104 may be a safety valve, a fail-safe valve, a pressure relief valve, a check valve, a clack valve, a non-return valve, a reflux valve, a retention valve, a one-way valve, and so forth. For example, the second portion 408 of the second valve 104 may be a one-way ball check valve. The one-way ball check valve may allow material (such as gas, vapors, or flames) to flow from the cavity or chamber of the liquid container 100 to outside the liquid container 100 while stopping material, such as liquid or air, from flow into the cavity of chamber of the liquid container 100 through the second valve 104. The second portion 408 of the second valve 104 may include the cap 404, a closing member 420, and/or an opening 414.

The closing member 420 may be configured to have a closed position to restrict the flow of material from the opening 424 of the second portion 212 and an open position to allow the flow of material to the opening 422. To restrict or allow the flow of air to the opening 422, the closing member 420 may include a blocker 426 and a depressor 428. The blocker 426 may be positioned below the depressor 428. When upward pressure is applied to the blocker 426 from material within the liquid container 100, the upward pressure may be channeled through the opening 424 to lift or raise the blocker 426 and compress the depressor 428. The blocker 426 may be a ball, a disk, a plate, and so forth. The depressor 428 may be a spring, a coil, a mechanical actuator, and so forth. The blocker 426 and/or the depressor 428 may be a metal material, a plastic material, a rubber material, a glass material, and so forth. For example, the blocker 426 may be a ball and the depressor 428 may be a spring. The blocker 426 may rest on below of the spring. In one example, the blocker 426 may be pressed downward against a perimeter of the opening 424 by the depressor 428.

For example, FIG. 4C shows the closing member 420 in a closed position where the spring is decompressed into a decompressed configuration and the spring is pressing the ball downwardly into the opening 424 to form a seal around the opening 424. In one example, a seal 430 may circumscribe the opening 424. For example, the seal 430 may be an O-ring that circumscribes the opening 424. The spring may press the ball downwardly into the seal 430 to form a seal between the seal 430 and the ball. When the ball forms a seal with the seal 430 and/or the opening 424, material (such as a gas, a liquid, or vapors) may not pass through the closing member to the opening 422.

The cap 404 may be located at a top of the second portion 408 that faces the outside or exterior surface of the liquid container 100. The cap 404 may include the opening 422 for the material from the cavity or chamber of the liquid container 100 to pass from an opening 424 at the bottom of the second portion 408 to the opening 422. For example, the cap 404 may be affixed to an inner wall 432 of the second portion 408 of the second valve 104 at the top or approximate the top of the second portion 408. When the cap 404 is affixed to the inner wall 432 of the second portion 408, the cap 404 may retain the depressor 428 within a cavity of the second portion 408 of the second valve 104.

FIG. 4D illustrates the closing member 420 in an open position, according to one embodiment. Some of the features in FIG. 4D are the same or similar to some of the features in FIGS. 1 and 4A-4C as noted by the same reference numbers, unless expressly described otherwise. When a threshold amount of pressure is applied to the depressor 428 to compress the depressor 428, the closing member 420 may be in the open position where there is a gap between the blocker 426 and the opening 424 and/or the seal 430 to allow material to flow through the gap to the opening 422. In one example, material from the bottom side of the second portion 408 may apply pressure to the blocker 426 to compress the depressor 428 and allow the material to flow to the opening 424. In another example, as pressure builds up within the liquid container 100, the pressure from within the cavity may be vented toward the opening 424 and the pressure may create an upward force that pushes the blocker 426 upward to compress the depressor 428. As the depressor 428 compresses, the closing member 420 may switch from a closed position to an open position and allow the material to exit the cavity or chamber of the liquid container 100 via the opening 422. A tension or stiffness of the depressor 428 may limit a range that the blocker 426 may lift or raise the depressor 428.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and sub-combinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and sub-combinations of the disclosed inventions that are believed to be novel and non-obvious. Inventions embodied in other combinations and sub-combinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A liquid container comprising:
a body comprising a cavity to store a liquid;
a first valve connected to the body, wherein the first valve comprises:
a first housing that includes a first conduit connecting a first opening at a top of the first valve to a second opening at a bottom of the first valve, wherein the top of the first valve faces an exterior of the first housing and the bottom of the first valve faces the cavity of the first housing;
a first set of threads circumscribing at least a portion of the exterior surface of the first valve, wherein the first set of threads comprise a channel extending vertically through at least a portion of the first set of threads;
a cover configured to attach to the first set of threads; and
a first closing member located within the first conduit, wherein the first closing member is to control a flow of first matter from the first opening to the second opening; and
a second valve, comprising:
a second housing that includes a second conduit connecting a third opening at a top of the second valve to a fourth opening at a bottom of the second valve, wherein the top of the second valve faces an exterior of the second housing and the bottom of the second valve faces the cavity of the second housing; and
a second closing member located within the first conduit, wherein the second closing member is to control a flow of second matter from the fourth opening to the third opening.

2. The liquid container of claim 1, wherein the first valve is a one-way ball valve to allow the first matter to flow into the cavity and restrict the liquid from flowing out of the cavity.

3. The liquid container of claim 1, wherein the first closing member comprises:
a cap approximate to the first opening, wherein the cap comprises:
a top surface facing the first opening and a bottom surface facing the second opening; and
a fifth opening extending from the top surface of the cap to a bottom surface of the cap;
a seal connected to a bottom surface of the cap, wherein the seal circumscribes the fifth opening on the bottom side of the cap;
a blocker located below the bottom surface of the cap, wherein the blocker is shaped to form a seal around the fifth opening when the blocker is pressed up against the seal; and
an elevator connected to a portion of the first housing of the cap below the blocker, wherein the elevator is configured to exert upward pressure on the blocker toward the seal.

4. The liquid container of claim 3, wherein when the elevator is in a decompressed configuration the first closing member is in a closed position to restrict the flow of the first matter from the first opening to the second opening.

5. The liquid container of claim 3, wherein when the elevator is in a compressed configuration the first closing member is in an opened position to allow the flow of the first matter from the first opening to the second opening.

6. The liquid container of claim 1, wherein the second valve is a one-way ball valve to allow the second matter to flow out of the cavity and restrict the first matter from flowing into the cavity.

7. The liquid container of claim 1, wherein the second closing member comprises:
a cap approximate to the third opening, wherein the cap comprises:
a top surface facing the first opening and a bottom surface facing the second opening; and
a fifth opening extending from the top surface of the cap to the bottom surface of the cap;
a blocker located at a bottom portion of the second housing, wherein the blocker is shaped to form a seal around a sixth opening at a bottom of the second housing when the blocker is pressed up against a perimeter of the second housing circumscribing the sixth opening; and
a depressor coupled to the cap below the blocker, wherein the depressor is configured to exert downward pressure on the blocker toward the sixth opening.

8. The liquid container of claim 7, wherein when the depressor is in a decompressed configuration the second closing member is in a closed position to restrict the flow of the second matter from the fourth opening to the third opening.

9. The liquid container of claim 7, wherein when the depressor is in a compressed configuration the second closing member is in an opened position to allow the flow of the second matter from the fourth opening to the third opening.

10. The liquid container of claim 1, wherein the cover comprises a second set of threads configured to screw onto the first set of threads, wherein an amount of the second set of threads that are screwed onto the first set of threads controls a rate that the first matter flows into the first opening.

11. The liquid container of claim 1, wherein the second matter is a flame and the second valve is configured to releases the flame out of the cavity through the third opening.

12. A liquid container comprising:
a body comprising a cavity to store a liquid; and
a valve connected to the body, wherein the valve comprises:
a housing that includes a conduit connecting a first opening at a top of the valve to a second opening at a bottom of the valve, wherein the top of the valve faces an exterior of the housing and the bottom of the valve faces the cavity of the housing;
a first set of threads circumscribing at least a portion of an exterior surface of the valve, wherein the first set of threads comprise a channel extending vertically through at least a portion of the first set of threads;
a cover configured to attach to the first set of threads; and
a closing member located within the conduit, wherein the closing member is to control a flow of matter from the first opening to the second opening.

13. The liquid container of claim 12, wherein the cover comprises a second set of threads configured to screw onto the first set of threads, wherein an amount of the second set of threads that are screwed onto the first set of threads controls a rate that the matter flows into the first opening.

14. The liquid container of claim 13, wherein:
when the second set of threads are screwed onto the first set of threads a first defined amount, the matter flows into the first opening at a first rate; and
when the second set of threads are screwed onto the first set of threads a second defined amount, the matter flows into the first opening at a second rate.

15. The liquid container of claim 14, wherein the closing member comprises:
a cap approximate to the first opening;
a blocker located approximate a bottom portion of the housing, wherein the blocker is shaped to form a seal around a third opening at the bottom portion of the housing; and
a depressor coupled to the cap, wherein the depressor is configured to exert downward pressure on the blocker to form the seal.

16. The liquid container of claim 14, where the cover comprises a seal that circumscribes a portion of an inner cavity of the cover.

17. A liquid container comprising:
a body comprising a cavity to store a liquid;
a valve, comprising:
a housing that includes a conduit connecting a first opening at a top of the valve to a second opening at a bottom of the valve, wherein the top of the valve faces an exterior of the housing and the bottom of the valve faces the cavity of the housing; and
a closing member located within the conduit, wherein the closing member is to control a flow of matter from the second opening to the first opening.

18. The liquid container of claim 17, wherein the valve is a safety valve to release the matter from the cavity.

19. The liquid container of claim 17, wherein the matter is a flame or gas vapor.

20. The liquid container of claim 19, wherein:
when the closing member is in a closed position, the closing member is configured to restrict the flow of the matter from the second opening to the first opening; and
when the closing member is in an open position, the closing member is configured to allow the flow of the matter from the second opening to the first opening.
